(19) United States
(12) Patent Application Publication
(10) Pub. No.: US 2012/0036536 A1
(43) Pub. Date: Feb. 9, 2012

(54) SYSTEMS AND METHODS FOR UPDATING INFORMATION IN REAL TIME FOR USE IN A MEDIA GUIDANCE APPLICATION

(75) Inventors: Walter R. Klappert, Los Angeles, CA (US); Mitch Drummond, Tulsa, OK (US); William L. Thomas, Malvern, PA (US); Michael McCarty, Agoura Hills, CA (US)

(73) Assignee: ROVI TECHNOLOGIES CORPORATION, Santa Clara, CA (US)

(21) Appl. No.: 12/851,915

(22) Filed: Aug. 6, 2010

(51) Int. Cl. H04N 5/445

(52) U.S. Cl. 725/50

(57) ABSTRACT

Systems and methods are provided for updating a media guidance application with real-time media information for enhancing recording features. In particular, real-time schedule changes, actual and estimated, are provided for updating instructions for a media guidance application operation.

### BACKGROUND OF THE INVENTION

This invention relates generally to media guidance applications, and in particular, to providing real-time updates of media information in a media guidance application for enhancing the performance of media recordings and other media guidance application features.

A user may record media using a media guidance application using a recording instruction. The recording instruction typically includes media scheduling and availability information for the media to be recorded. In a conventional media storage system, after the recording instruction is entered, changes to the scheduling or availability of the media may cause the media recording to be incomplete. In some conventional media storage systems this problem is mitigated by adding a buffer period to the beginning and end of a recording time. However, the extended buffer period solution may still result in recording problems because the buffer period may not be adequate. Additional extensions of time for the buffer period may increase the likelihood that complete media recordings are performed, however the extended recording time will utilize excessive storage capacity. In addition, the use of buffer periods may cause overlaps and conflicts with subsequent recordings.

### SUMMARY OF THE INVENTION

Accordingly, systems and methods are described herein for updating a media guidance application with real-time media information for improving media recording effectiveness. Recording instructions, whether system or user initiated, may be entered and stored in a media recording system. The recording instruction may include information related to a media asset selected for recording, such as an identifier for the selected media asset. Other information related to the selected media asset may also be included in the recording instruction, such as a start time, end time, source for the selected media asset, or other availability-related information for the selected media asset. Prior to performance of a media recording based on the recording instructions, update information related to the selected media asset may be obtained using data received from a non-media information source, such as a media update data feed, a sports ticker data feed, sports websites, sports scoreboards, web blogs, and social network comments. The non-media information source data may be used to generate update information which may be analyzed to determine whether it includes data that is different from the data included in the recording instruction. If the update information data differs from the recording instruction data, the recording instruction may be updated to include the update information. Update information may also be obtained during performance of the media recording, and the recording instruction may be updated as necessary. Following completion of the media recording, update information, including actual start and end times, may also be obtained. The actual start and end times may be used to remove any excess recordings on a media storage device in the event the recording extended longer than the media start and/or end time. The end time may also be used to determine whether portions of the media recording were missed because the recording ended prior to the end time. If material is missing in the recording, the media guidance application may update the recording by obtaining the missed material from another source.

The update information may be based on data obtained from one or more non-media information sources. Such sources may be monitored to obtain and aggregate data relevant to performing certain media recordings. Since non-media information sources typically do not provide media data in a format that is immediately useful by a media guidance application, the media data provided by non-media information source may require analysis to provide relevant update information to a media guidance application.

Certain non-media information sources may be used for providing update information data for particular media assets. The non-media information sources used for update information may be identified using a media attribute of the media asset. The media attributes for the media asset may be included in a recording instruction or in the media asset profile, and used to identify associated non-media information sources. For example, a sports media attribute may be included in a recording instruction or a data profile for a sports event. The sports media attribute may be used to identify certain sports information sources for monitoring for data relevant to media updates for the sports event. The non-media information sources may be used individually or in combination when supplying data for update information. Each non-media information source may be assigned a reliability score which may be used to determine whether to use information from each source alone or in combination with other sources.

Using real-time update information to update a recording instruction may cause recording conflicts to arise which were not known at the time the recording instructions were initially entered. For example, a recording instruction for a media asset that is scheduled to follow an extended live performance event may result in a conflict because the following media asset may start and end later than expected or overlap with the extended live performance event. Media assets following content having an extended overrun can be pre-empted entirely or rescheduled. Such conflicts can be resolved by a user or automatically by the system.

The update information may be provided by a data feed of aggregated data from one or more of the non-media information sources. The data feed of update information may include data that is determined to differ from media information received from a media information source, such as a media guidance application listings data source. The update information data feed typically includes an identifier associated with a media asset, a title of the media asset, a start time of the media asset, an end time of the media asset, a source of the media asset, an estimated overrun of the schedule for the media asset, a time stamp of the media information update, and a time of the next media information update. The information included in the data feed may be generated based on data provided by one or more non-media information sources. The data feed may be an RSS feed, EBIF feed, or other data feed type.

### BRIEF DESCRIPTION OF THE FIGURES

The above and other objects and advantages of the invention will be apparent upon consideration of the following detailed description, taken in conjunction with the accompanying drawings, in which like reference characters refer to like parts throughout, and in which:

FIG. 1A shows an illustrative system in accordance with an embodiment of the invention.

FIGS. 1-2 show illustrative display screens that may be used to provide guidance for online video and other types of media.

FIG. 3 shows an illustrative user equipment device in accordance with an embodiment of the invention.

FIG. 4 shows an illustrative system in accordance with an embodiment of the invention.

FIG. 5 depicts an illustrative data structure for a media asset in accordance with embodiments of the invention.

FIG. 6 depicts an illustrative data structure for a media information update in accordance with embodiments of the invention.

FIG. 7 depicts an illustrative table associating media attributes and update sources in accordance with embodiments of the invention.

FIG. 8-11 show illustrative flow diagrams for updating a media guidance application in accordance with embodiments of the invention.

### DETAILED DESCRIPTION OF EMBODIMENTS

The amount of media and media information available to users in any given media delivery system can be substantial. Consequently, many users desire a form of media guidance through an interface that allows users to efficiently navigate media selections, easily identify media that they may desire, and obtain such media. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, smartphones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, smartphones, or other mobile devices. The various devices and platforms that may implement media guidance applications are described in more detail below.

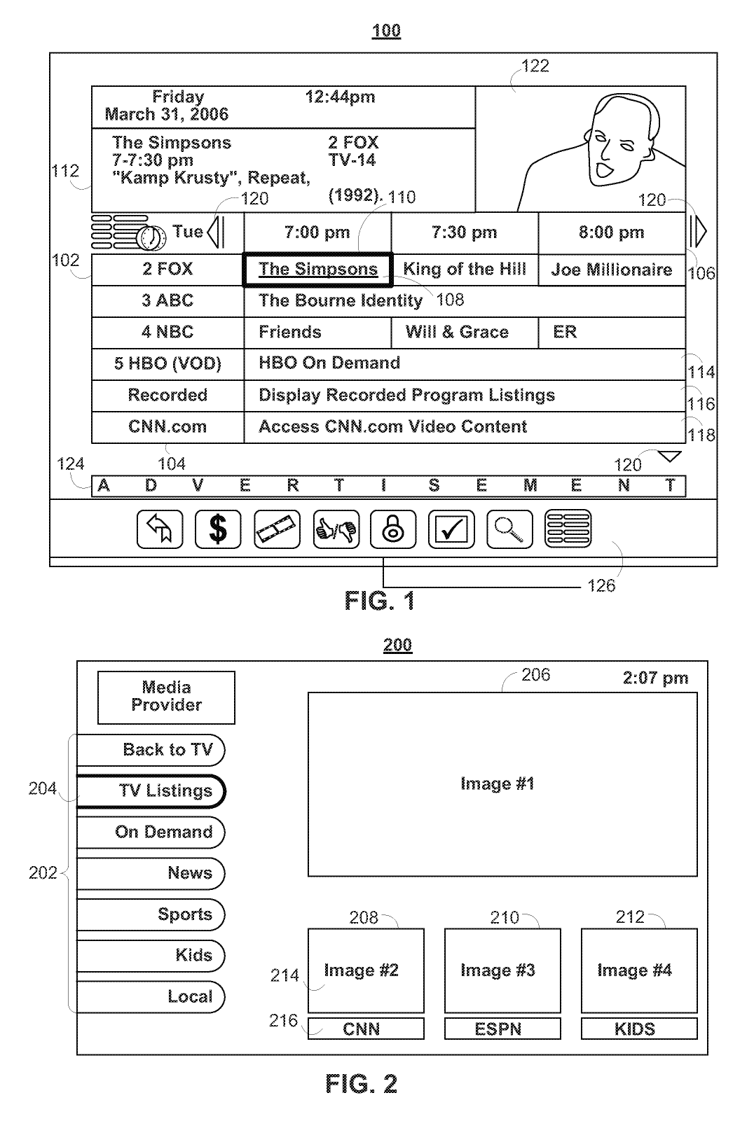

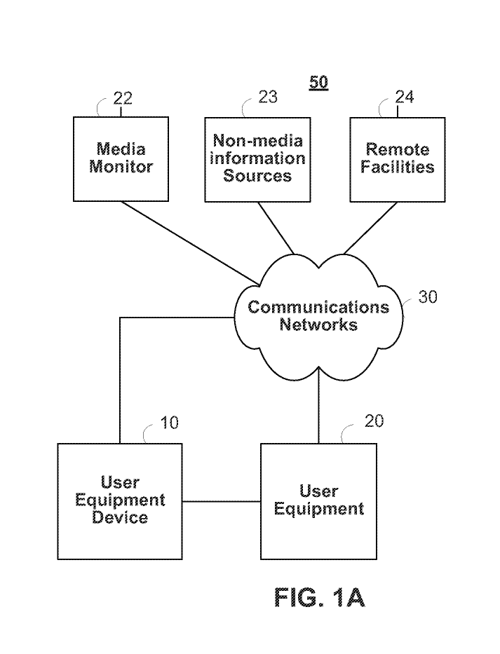

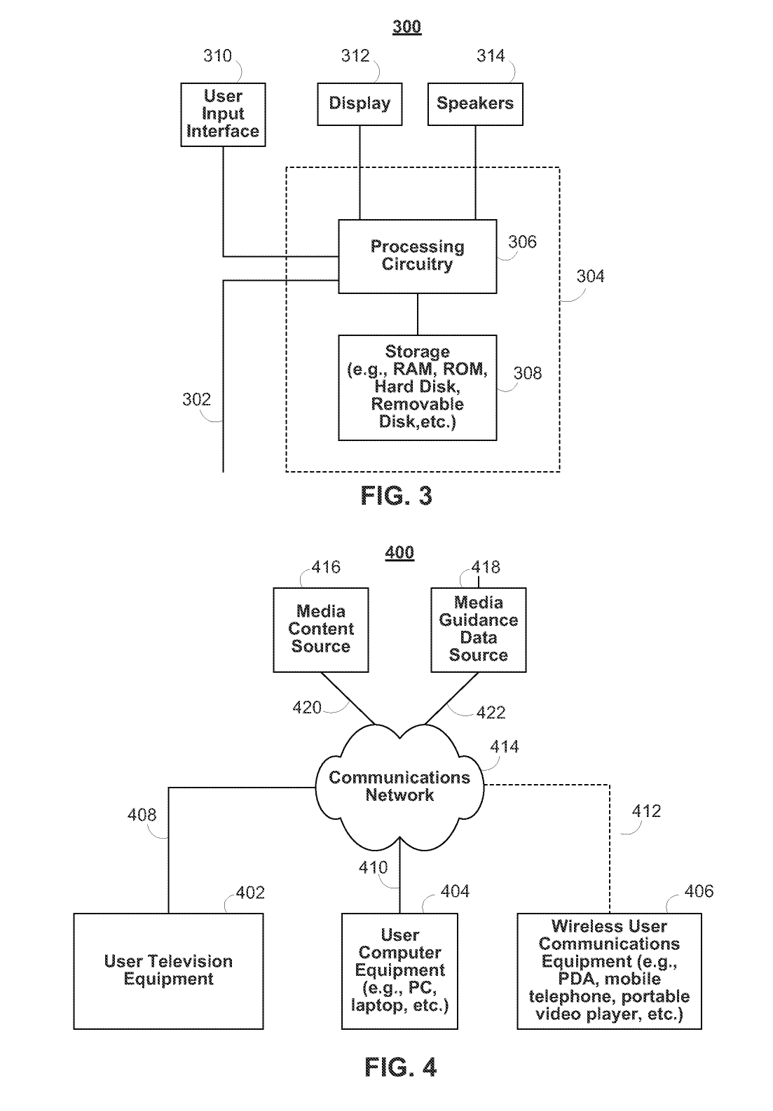

The inventions disclosed herein relate, broadly speaking, to systems and methods for updating media information in real-time, for use in media recording, or other media system operations. Some examples of media system operations may include setting reminders for media assets, providing information about media in a search context, parental control settings, media consumption monitoring. As will be understood by one of skill in the art, the inventions disclosed herein may be used with many combinations of media sources and media components, and used with a media guidance application to provide a variety of media operations. One exemplary system for implementing the inventions described herein is depicted in FIG. 1A which shows user equipment device 10 which may be implemented with user equipment 20. User equipment device 10 may be used to access media content and a media guidance application, further described herein. The user equipment device 10 may be the user equipment device 300 described in reference to FIG. 3. User equipment 20, such as a television, computer, handheld device, or other equipment, may be used with user equipment device 10 to access media content. User equipment 20 may include the user equipment components discussed in connection with FIG. 4, such as the user television equipment 402, user computer equipment 404, wireless user communications equipment 406, internet television, or any other type of user equipment suitable for accessing media using user equipment device 10/300 which may be separate or integrated with user equipment 20. For example, some integrated user equipment and user equipment devices may be a set-top box integrated television or computer, or WebTV, or other integrated arrangement.

User equipment device 10 and user equipment 20 may be in communication with a media monitor 22, sources 23 and remote facilities 24 via one or more communications networks 30. The communication networks 30 may include private and public communications networks, as well as the networks disclosed for communications network 414.

In system 50 a user may use user equipment device 10, such as a computer or set top box, to record a media asset, such as a sports event, which may be viewed using user equipment 20, which may be a computer, mobile device, television, or other device. The recording of the media asset can be set by the user by entering a recording instruction in the user equipment device 10. The user may use media listings information supplied by a media guidance application in the selection of the media asset for recording. Media listings information may also be used in the recording instruction. In advance of, during, and following completion of the recording, update information about the media may be received based on data from one or a combination of non-media information sources, such as a media monitor 22, sources 23, and/or remote facilities 24. Such update information may be useful, in particular, when recordings are made of live performances and sports events which may often have scheduling changes to accommodate, for example, overtime periods and encore performances. The update information can be used to revise the recording instruction so that the recording is performed properly without beginning late or ending early.

The update information may be obtained from a variety of non-media information sources. Some non-media information sources may provide update information in a format that is usable by user equipment device 10 or user equipment 20. Other non-media information sources may provide data that must be analyzed and formatted for use by user equipment device 10 or user equipment 20. In this scenario, the data may be collected or received by the user equipment device 10, user equipment 20, or a headend 24. The data may be aggregated from several sources for analysis, or analyzed individually. The data may also be formatted by the user equipment device 10, user equipment 20, or a headend 24, into an update information format that can be used in a media guidance application.

One non-media information source may be a media monitor 22 which monitors media and provides update information about media. Some examples of media monitors 22 may include dedicated viewers and cohorts of viewers. Such viewers may be typical media consumers, as well as viewers who are experienced with predicting scheduling overruns. The media monitors 22 may use information obtained from live media viewing, as well as non-media information sources, such as sources 23. Non-media information sources 23 providing media update information may include websites which may directly provide updates to media monitor 22 or which may be polled to obtain update information. Source 23 may include websites such as social networking websites, news websites, sports websites, and other websites that may be relevant to media. For example, Twitter website tweet data may be aggregated to identify comments relating to a media asset, and which may be analyzed to determine if the comments indicate a scheduling change. More specifically, tweets indicating that overtime is underway for a sports event, a sports event is rained out, that an artist is performing an encore, or that an award winner is making a long acceptance speech may be used to provide media update information.

Remote facilities 24 may also provide media update information. Remote facilities 24 may be a media headend, media distribution point, regional facility, national facility, or other facility that provides media information updates. The remote facility 24 may generate update information based on analysis of media assets and media information. The remote facility 24 may also poll sources 23 to obtain media information that may be useful for generating update information. The remote facility 24 may also receive update information directly from sources 23 and/or media monitor 22. The media update information received from the non-media information sources may be used to update recording settings or other instructions for media operations using the media guidance application.

The functionality discussed above may be implemented using the media guidance display screens shown in FIGS. 1-2 in conjunction with the user equipment device 300 depicted in FIG. 3 and user equipment system depicted in FIG. 4.

FIGS. 1-2 show illustrative display screens that may be used to provide media guidance, and in particular media listings. The display screens shown in FIGS. 1-2 may be implemented on any suitable device or platform. While the displays of FIGS. 1-2 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The selectable options region 126 may include a recording option, which when selected causes a highlighted listing in the program listings grid 102 to be recorded by setting a recording instruction in the media guidance application for a recording to a recording device. The recording instruction typically includes at least information identifying the selected program for recording. Program recordings may also be set by a user by selecting a listing in the grid 102 and entering a record command, which will cause a recording instruction for the selected listing to be set.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

Users may access media content and the media guidance application (and its display screens described above and below) from one or more of their user equipment devices. FIG. 3 shows a generalized embodiment of illustrative user equipment device 300. The user equipment device 300 may be used in connection with the system discussed in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device or smartphone, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the Enhanced Television Binary Interchange Format (EBIF), received by control circuitry 304 as part of a suitable feed, and interpreted by a user agent running on control circuitry 304. For example, the guidance application may be an EBIF application. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications equipment 406, internet television, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, an internet connected television, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications equipment 406 may include PDAs, a mobile telephone, smartphones, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications equipment 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment or a portable digital device such as an iPad, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a mobile digital device and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications equipment 406 are coupled to communications network 414 via communications paths 408, 410, and 412, respectively. Communications network 414 may be one or more networks including the Internet, a mobile phone network, mobile device or smartphone (e.g., Blackberry, iPhone) network, cable network, public switched telephone network, or other types of communications network or combinations of communications networks. BLACKBERRY is a service mark owned by Research In Motion Limited Corp. iPhone is a trademark owned by Apple Inc. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment 402, 404, and 406 are shown as through communications network 414, in some embodiments, sources 416 and 418 may communicate directly with user equipment 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections. Media guidance data source 418 may also be multiple data sources of varying types. For example, media guidance data source 418 may be media related websites, such as fantasy sports sites, fan websites, and other websites including information relevant to media assets and media listings. Media guidance data source 418 may also include a data feed of media listing updates. Such a data feed could be provided using an RSS or EBIF data feed that includes only new updated information. Media guidance data source 418 could also provide media guidance update data obtained via social network websites.

Media guidance application data and updated data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a web-enabled mobile telephone or iPad. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 402 and user computer equipment 404 may access the media guidance application to navigate among and locate desirable media content. Users may also access the media guidance application outside of the home using wireless user communications equipment 406 to navigate among and locate desirable media content.

It will be appreciated that while the discussion of media content has focused on video content, the principles of media guidance can be applied to other types of media content, such as music, images, etc.

As discussed herein, the interactive media guidance application may be used to identify media of interest and perform recordings of such media. When a recording feature is used by the user, a recording instruction may be received by the processing circuitry 306 and stored in storage 308. The recording instruction will typically include at least an identifier of the media asset selected for recording, so that an associated media profile may be obtained to ascertain additional information about the asset selected for recording.

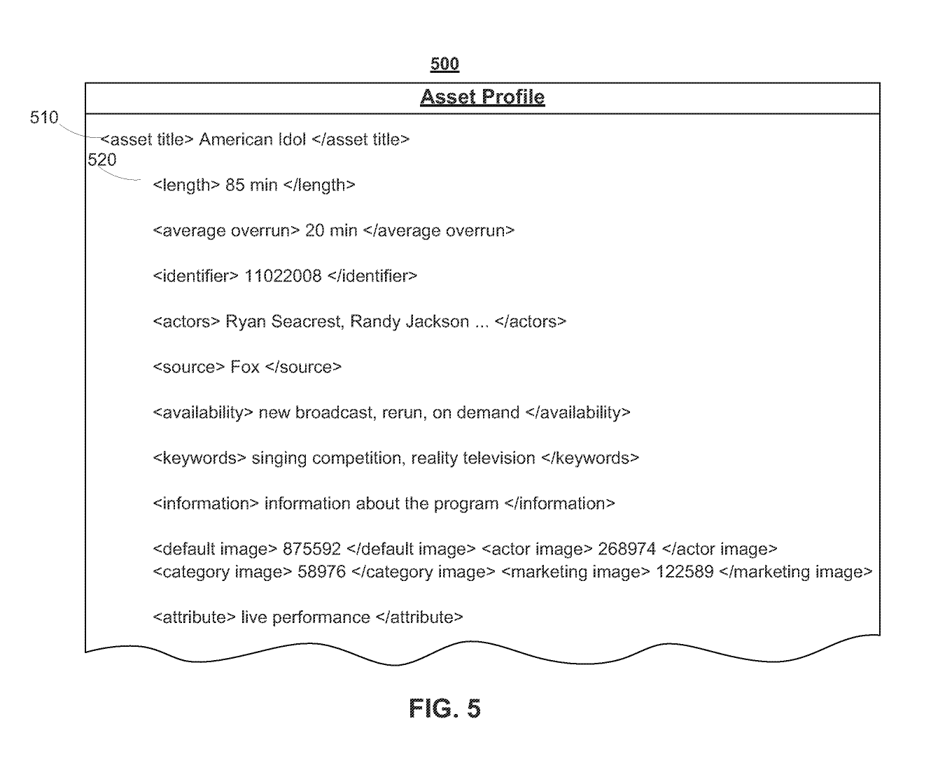

An example of a media profile data structure is depicted in FIG. 5 and can include any information, in any combination, associated with the media asset, including for example, an asset title 510, and other information 520, such as length, average overrun information, identifier, actors, channel or source, availability, keywords, information, associated images, and attributes. Such asset information may be useful in providing media guidance application features, for example, in the recording context, the asset information is useful in determining whether a media asset selected for recording is likely to have scheduling updates or overruns. Also in the recording context, the identifier may be used to identify an asset for recording and may include asset code, series code, episode code or other asset identifying information.

A schedule overrun occurs when a media asset, often a live event, extends beyond its scheduled time, or incurs some other change in schedule or availability. For example, a live sports event may have unexpected overtime periods that cause it to exceed its scheduled end time. The overrun may also cause a following program to be pre-empted or rescheduled. Average overrun information for a particular media asset or class of assets may be included in an asset profile and may offer an indication that the item selected for recording is also likely to overrun its scheduled time. Average overrun information may be obtained using actual overrun data for similar or comparable events. An attribute of the asset may also indicate that it is likely to overrun its scheduled time. For example, live performances, sports events, awards ceremonies often deviate from their respective scheduled times due to impromptu encore performances, extra innings or overtime, and extended thank you speeches, etc. Another type of schedule change may be caused when content is removed or substituted. For example, when a live sports event is cancelled due to weather, a substitute program may be made available. The identification of media assets likely to deviate from their scheduled times is useful for adjusting recording instructions, however, the use of real-time scheduling updates may provide enhanced recording functionality.

Real-time updates for media listings information may be obtained from media guidance data source 418, or other non-media guidance data sources, such as sources 23. Some examples of non-media guidance data sources include: media update data feeds, sports ticker data, sports scoreboard, websites, web blogs, and website comments. Such sources typically do not provide media data in a format that is immediately useful by user equipment 402/404. The media data provided by non-media guidance data source may require analysis and aggregation, as described herein, to provide relevant update information to a media guidance application.

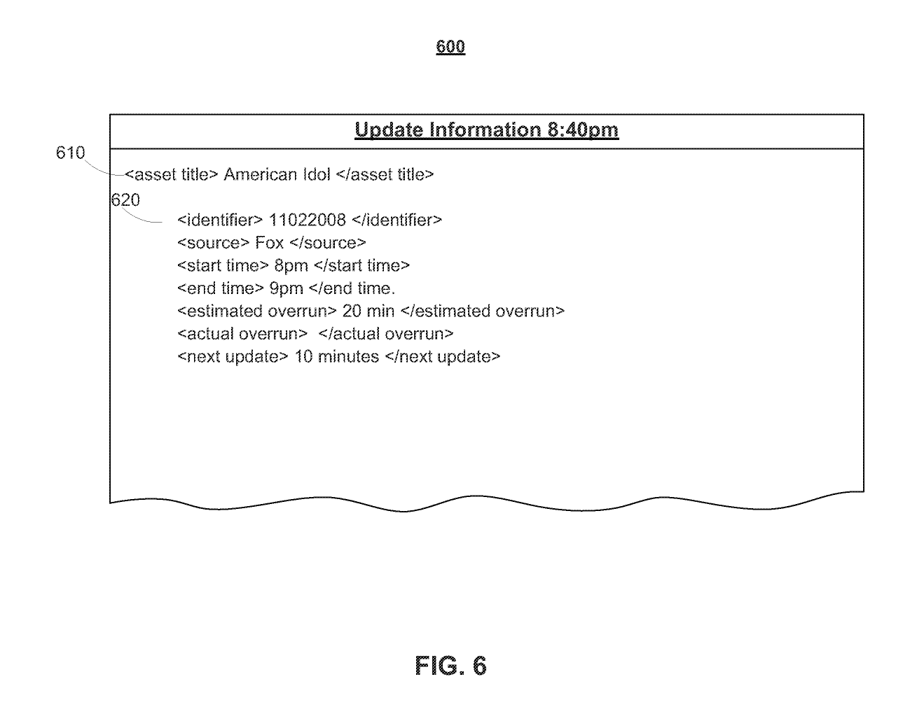

An example of a data structure of update information is presented as FIG. 6. The update information may be created by a data aggregating processor that may consult one or more sources for media information. Some information included in an update information may include a time stamp, asset identifier, channel, time, estimated overrun, actual overrun, next update time, preemption information, content change, or other information. The estimated overrun and actual overrun information may be used to update a recording instruction using processing circuitry 306 and included in an updated recording instruction stored in storage 308 both prior to and during a recording operation. The actual overrun or underrun information may be obtained in an update following an asset end time, and which may be used by the processing circuitry 306 to send instructions to a recording device, such as a DVR, to delete excess stored data.

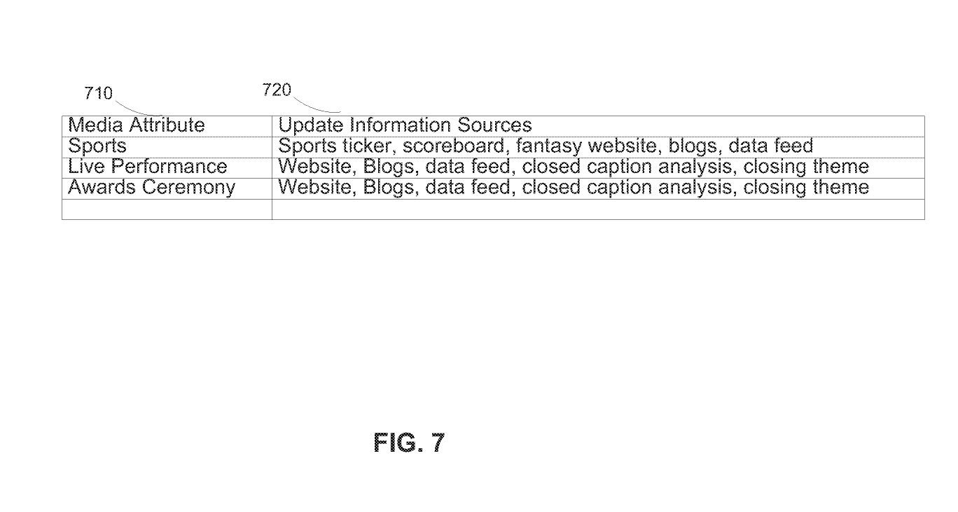

One or more media data sources 418 or non-media information sources 23 may be used to obtain update information. For media having certain attributes, some media data sources 418 or non-media information sources 23 may be more relevant than others. Processing circuitry 306 may be configured to support identification of a media attribute using a media asset data structure, which may be associated with an update information source in a table, such as that shown in FIG. 7. For example, for a sports media asset, update information about the asset may be obtained from a sports ticker, a scoreboard, fantasy sports websites, a team's website, sports blogs, or one or more data feeds. As discussed previously, the media guidance data sources 418 and sources 23 can communicate with user equipment 402/404/406 to provide update information directly, or update data that is analyzed and formatted by the user equipment 402/404/406. The media guidance data sources 418 and non-media information sources 23 can also communicate with a head end or other central clearinghouse for aggregating, analyzing and formatting update information that can be communicated to user equipment 402/404/406, for example, using a data feed. Media guidance data sources 418 and non-media information sources 23 can also be dedicated update data feeds that provide information based on an analysis of aggregated information, described herein.

The previously mentioned non-media information sources 23 can provide data regarding media assets in different ways. For example, a sport ticker, which may be obtained from any sports ticker data source, may be used to obtain score and time information for a game or match. Often the sports ticker data will include a final score for a completed game. A final score identifier can be used as an indication that the game or sports event is complete. Such information could be packaged as update information to indicate that a game or match has ended and that a recording of such game can end. The score information can also indicate that extra innings or overtime is underway. Such information can be used to trigger update information that indicates an extended overrun time. Score information can also be used directly from sources, especially from sources designated as trustworthy, to send update information, or compared against information received from other sources in order to verify the information. For example, an ESPN sports ticker may be designated as a trustworthy source and used for updates directly. By contrast, fantasy sports websites, web blogs, and social network websites, for example, twitter updates indicating game scores may require verification by comparison against information received from other sources. Scoreboard information may also be used to obtain game updates. For example, when a game is viewed or recorded for viewing later, processing circuitry 306 can be configured to analyze scoreboard information on the screen. In general, scoreboards are shown in the same location and the information used to create the scoreboard display can be obtained by processing circuitry 306 and analyzed to determine, for example, a game period, time remaining, over time, extra innings, current score, or final score. Such information can be used to provide overrun estimates.

For other types of media, such as live performances and awards ceremonies, which often have schedule overruns, update information sources can provide data for real overrun estimates in ways similar to those discussed in reference to sports matches. For example, awards ceremony websites and web blogs may provide information indicating the winners and the relative progress of the event. In addition, text in closed caption information for the event can be analyzed, for example by processing circuitry 306 or a processor at a remote facility 24, to assess the progress of the event. The closed caption text data can be analyzed to determine that an event has ended, for example by looking for word cues. Closing theme song analysis can also be used to determine that an event has ended. For example, processing circuitry 306, or a processor at a remote facility 24 can analyze the sound associated with a media asset to detect the beginning of a closing theme song, which may be known and stored in a media asset profile. If the closing theme song is unknown it may be detected using analysis of audio components of a media asset to identify, for example, a continuing musical score without voice audio.

The previously mentioned data sources and analysis techniques are described by way of example only and can be used in any combination and with a variety of devices in order to obtain information relevant to media updates. The update information sources can also include data generated by a group of dedicated viewers who send media update information to a central processor for aggregation. Update information can also be obtained from a user's cohort or social circle. In such a scenario, the user may designate the social circle or cohort members with a reliability level for their update information. The reliability information can be used by the media guidance application to determine whether to use the update information supplied by another member.

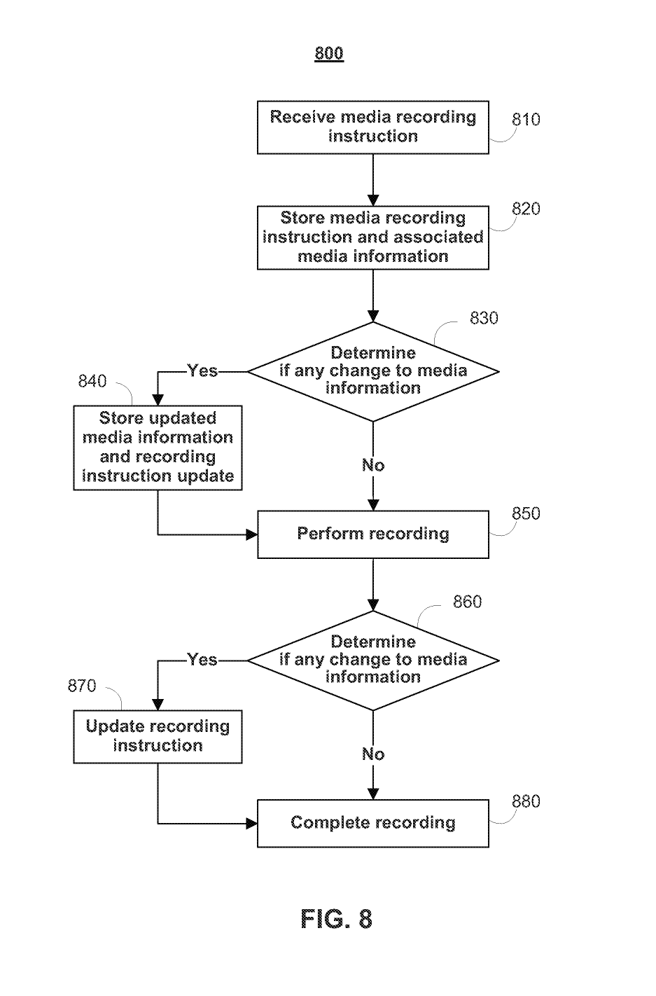

A television widget or application, or computer application, may also be used to provide data as well as analyze data updates using an application that is run separately, but in conjunction, with the media guidance application. The techniques described herein can be equally applied to home based media and recording environments as well as remote recording systems. For example, recordings may be set using a work or home computer or settop box for recordings made to remote storage facilities. The techniques described herein may be used in connection with the processes described with reference to the flow charts of FIGS. 8-11.

Turning to FIG. 8, media update information may be integrated with recording instructions using the steps of 800. The media update information may also be used to update guidance application schedules, as well as guidance features globally, or selectively, for example, if use of the feature is relevant to the media update information. To initiate the process 800, a media recording instruction may be received at step 810. The media recording instruction may be entered by a user using a media guidance application by selection of a program listing 102, an associated option 126, or other input mechanism. The recording instruction may be received by processing circuitry 306. The recording instruction may be stored in storage 308 with associated media information, such as a media identifier at step 820. The media identifier may be any aspect of the media asset to be recorded by the recording instruction, and which may be used to obtain a media asset profile 500.

On a periodic basis, or immediately prior to a start time of the recording instruction, processing circuitry 306 may be configured to determine at step 830 whether there are any updates to media information associated with asset to be recorded. This step may be of particular importance for recording media assets that follow a media asset that has had a schedule change. For example, if a preceding media asset overruns its schedule by 30 minutes, the following program will be delayed by 30 minutes. Without a recording instruction update to the start time, a recording of the following program may begin too early and end before the program has completed.

The update determination may be made by the processing circuitry 306 by polling media data sources 418, and/or non-media information sources 23, checking a dedicated update data feed, or other update source, as described herein. In some systems, the data feeds or other update information may be broadcast or transmitted to the media guidance application directly on a periodic basis or when update information is available so that periodic polling of external sources is not required.

In the event that an update to the media information is detected, the updated information may be stored at step 840 to storage 308 in association with the recording instruction. If no updates are detected, the recording may be performed using the processing circuitry 306 and storage 308 or DVR, at step 850 according to the original recording instruction.

During the recording operation, the media guidance application may continue to check for updated information so that real-time updates of schedule changes can be implemented in a recording. At step 860, processing circuitry 306 may check for media update information again. If changes to the media information are detected, at step 860, the recording instruction may be updated and stored in storage 308 at step 870. Updates will continue to be monitored during a recording and any updates will be associated with the recording instruction. If no changes to the media information are detected, the recording may be completed based on the recording instruction at step 880.

The process 800 may be optimized for certain types media assets. For example, when a recording instruction is received by processing circuitry 306, attributes and any associated overrun information for the media asset to be recorded, may be a basis for determining whether or how often to check for media update information. For some fixed length assets, such as reruns with known lengths, or first run episodes of established regular series (not season finales, for example), update checks may not be performed as frequently. For sports events and live performances, however, updates may be checked more frequently.

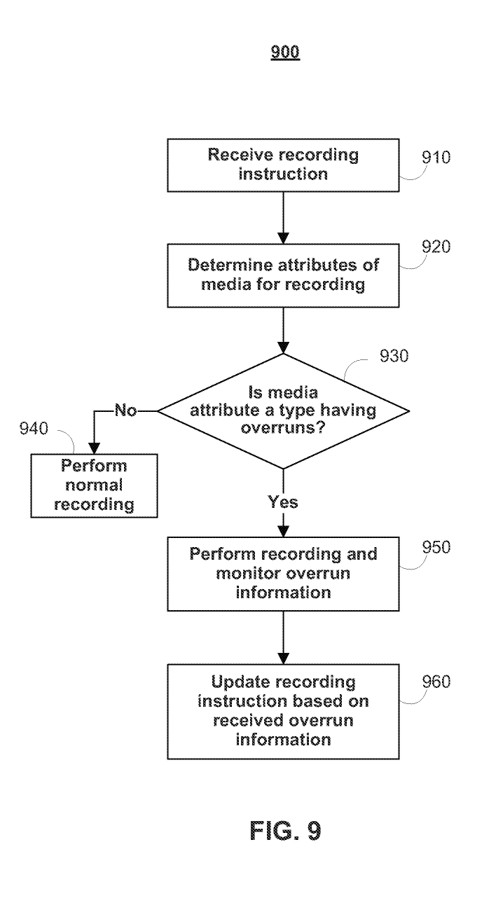

Turning to FIG. 9, when a recording instruction is received by processing circuitry 306 at step 910, a determination of attributes may be made by the processing circuitry 306 of the asset to be recorded, at step 920. The attributes of the asset may be obtained from an asset profile (e.g., data structure 500). The processing circuitry 306 may check whether the asset attribute is a type that has overruns or other scheduling irregularities at step 930. Such check may be performed by processing circuitry 306 by checking for overrun information, or comparing the attribute with a table of overrun attribute types. If there is no indication that the media asset has an attribute or other overrun tendency, the recording may be performed according the recording instruction at step 940. In some embodiments, real-time schedule update checks may not be performed for media assets having a low risk of overruns. In other embodiments, real-time schedule updates may be performed at a relatively reduced frequency.

If the media attribute is determined by processing circuitry 306 to be one that typically has overruns, the recording may be performed at step 950. Overrun information and media update information will be monitored as described herein by processing circuitry 306. The recording instruction will be updated at step 960 by processing circuitry to include any received update information.

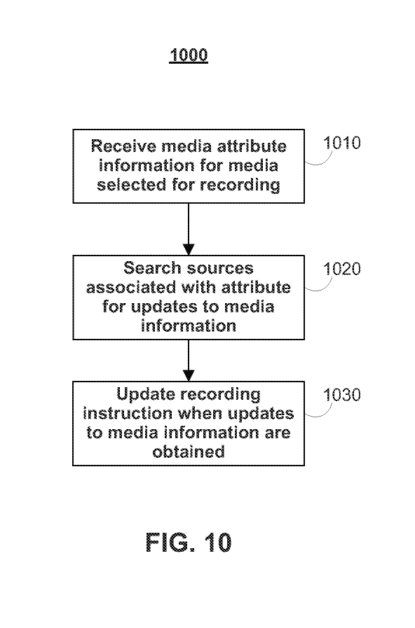

Turning to FIG. 10, a recording instruction and media attribute information are received by the processing circuitry 306 at step 1010 for media selected for recording. The processing circuitry 306 may check a table (e.g., the table of FIG. 7) for update sources associated with the media attribute. The associated sources may be searched by processing circuitry 306 for media update information at step 1020. Any update information may be integrated by the processing circuitry in an updated recording instruction, at step 1030. Such updated recording instruction may be stored in storage 308. The media asset attributes may also be used as a basis for setting update monitoring frequency.

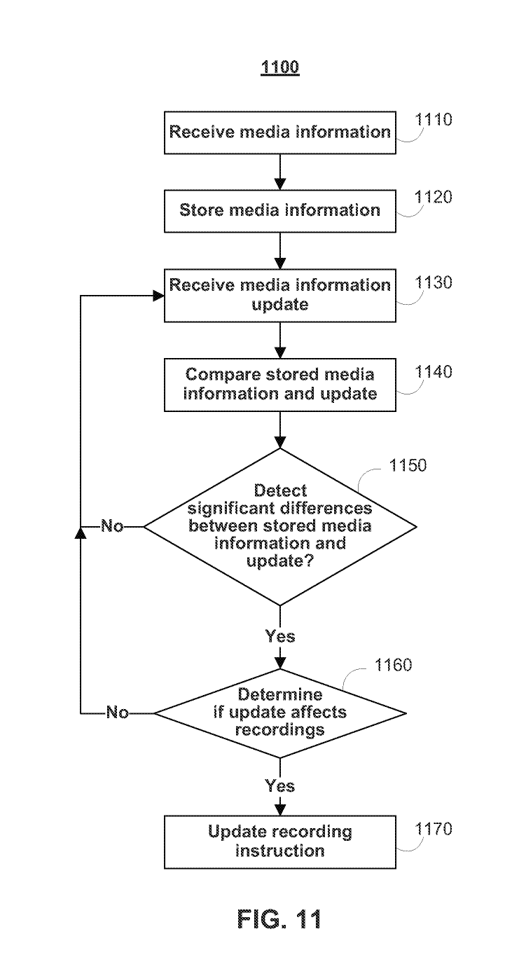

Although continuous update information monitoring and corresponding updates of recording instructions are useful for providing accurate recordings, repeated storage of recording update information may be unwieldy. In some embodiments, an original or prior media information associated with a recording instruction may be compared using processing circuitry 306 with updated media information for the media to be recorded to assess whether the information change is significant. Relative benchmarks indicating significance of changes can be set by the media guidance application or by the user and can vary according to media asset attributes. Data indicating such a benchmark may be stored in storage 308, for example, in a table including associations with media asset attributes. Such a process is described with reference to FIG. 11.

At step 1110, media information may be received by processing circuitry 306 from media guidance data source 418. The media information may be stored in storage 308 in association with a recording instruction at step 1120. Media update information may be received at step 1130 from media guidance data source 418. The update information may be compared by processing circuitry 306 at step 1140 with the previously stored media information. A threshold for differences between media information may be established and used as a benchmark for the comparison to assess whether any difference is significant. The thresholds may vary and can be based on media attributes, program length, and other bases. If the difference between the update information and the original media information is determined by processing circuitry 306 at step 1150 to be not significant, the process continues to cycle through receiving media update information and comparisons of the updated information at steps 1130-40.

If the update is determined at step 1150 to be significant, another determination is made at step 1160 by processing circuitry 306 as to whether the update will affect the recording. Such a determination may be made by, for example, comparing an overrun estimate with one being used in a recording instruction. If the update is determined to affect recordings at step 1160, the process returns to step 1130. If the update is determined to affect the recording, then at step 1170, processing circuitry 306 will integrate the update in a new recording instruction that may be stored in storage 308.

Changes in schedules can cause conflicts between recording instructions. For example, when a schedule overrun occurs, subsequent recordings may be affected if a system does not support multiple tuner functionality. In such a scenario, some conflict resolution is needed. Some examples of conflict resolution techniques are disclosed in commonly owned U.S. patent application Ser. No. 12/621,077, which is incorporated herein by reference.

When recordings are completed, media update information may be received for the completed recording. For example, an actual program end time may be received in a final media update. Such an update can include a designation of its finality with respect to a particular media asset. The actual program end time may be compared with the scheduled end time in the recording instruction using processing circuitry 306 to determine if the times are different. Any excess recordings can be removed by sending an appropriate instruction to the DVR or other storage device. Any under-recordings can be repaired by obtaining the missing content from a later broadcast of the content, or accessing the missing content from a media source or distribution facility. In some embodiments, following any recording instruction, the media guidance application may issue a request for updated schedule information for the recorded item in order to effectively manage the use of storage capacity. Such storage management techniques may be applied to user storage devices that are local or remote, such as user or network storage located at a headend facility.

The foregoing describes systems and methods for updating information in real time for use in an interactive media guidance application. The above described embodiments of the present invention are presented for purposes of illustration and not of limitation.

1. A method for providing real-time updates to media information for performing media recordings using a media guidance application at least partially implemented on processing circuitry, comprising:
receiving, using the media guidance application, a recording instruction, the recording instruction comprising at least an identifier of a media asset selected for recording;
storing in a storage device, the recording instruction, and media information associated with the selected media asset;
accessing a plurality of non-media information servers to receive media update data associated with the media asset;
aggregating the media update data using the processing circuitry;
based in part on the aggregated media update data, generating update information using the processing circuitry; and
updating the recording instruction based on the update information.

2. The method defined in claim 1 further comprising: determining, using the media guidance application, whether the update information is different from the recording instruction.

3. The method defined in claim 1 wherein the media information comprises a start time, an end time, a media asset source, and a media attribute.

4. The method defined in claim 3 wherein the attribute indicates a media asset overrun average.

5. The method defined in claim 3 wherein the attribute indicates a media asset type relevant to determining whether the media asset will incur a schedule overrun.

6. The method defined in claim 3 further comprising monitoring for updates to media information based in part on the media attribute.

7. The method defined in claim 3 further comprising monitoring non-media information sources based in part on the media attribute.

8. The method defined in claim 7 wherein the non-media information sources comprise at least one of the group of: media update data feed, sports ticker data, sports scoreboard, websites associated with the media asset, web blogs associated with the media asset, and social network comments associated with the media asset.

9. The method defined in claim 1 further comprising:
receiving, with the media guidance application, a second recording instruction for a second media asset;
determining, using the media guidance application, whether the updated recording instruction for the selected media assets conflicts with the second recording instruction; and
if a conflict exists, presenting the user with a conflict resolution options screen display, or
automatically resolving the conflict.

10. The method defined in claim 1 further comprising:
receiving, with the media guidance application, when a recording operation based on the updated recording instruction is completed by the media guidance application, a last information update associated with the media asset, the last information update associated with the media asset including at least the actual end time of the media asset; and
determining, using processing circuitry, whether the actual end time of the media asset is different than an estimated end time included in the updated recording instruction.

11. The method defined in claim 10 further comprising:
if the actual end time is earlier than the estimated end time, sending an instruction to the storage device to delete an excess recording; or
if the actual end time is later than the estimated end time, obtaining missing recording content from a media source.

12. A system for providing real-time updates to media information for performing media recordings using a media guidance application, the system comprising:
user equipment comprising processing circuitry configured to:
receive, using the media guidance application, a recording instruction, the recording instruction comprising at least an identifier of a media asset selected for recording;
store in a storage device, the recording instruction, and media information associated with the selected media asset;
access a plurality of non-media information servers to receive media update data associated with the media asset;
aggregate the media update data;
based in part on the aggregated media update data, generate update information using the processing circuitry; and
update the recording instruction based on the update information.

13. The system defined in claim 12 wherein the processing circuitry is further configured to: determine, using the media guidance application, whether the update information is different from the recording instruction.

14. The system defined in claim 12 wherein the media information comprises a start time, an end time, a media asset source, and a media attribute.

15. The system defined in claim 14 wherein the attribute indicates a media asset overrun average.

16. The system defined in claim 14 wherein the attribute indicates a media asset type relevant to determining whether the media asset will incur a schedule overrun.

17. The system defined in claim 14 wherein the processing circuitry is further configured to monitor for updates to media information based in part on the media attribute.

18. The system defined in claim 14 wherein the processing circuitry is further configured to monitor non-media information sources based in part on the media attribute.

19. The system defined in claim 18 wherein the non-media information sources comprise at least one of the group of: media update data feed, sports ticker data, sports scoreboard, websites associated with the media asset, web blogs associated with the media asset, and social network comments associated with the media asset.

20. The system defined in claim 12 wherein the processing circuitry is further configured to:
receive, via the media guidance application, a second recording instruction for a second media asset;
determine whether the updated recording instruction for the selected media assets conflicts with the second recording instruction; and
if a conflict exists, present the user with a conflict resolution options screen display, or
automatically resolve the conflict.

21. The system defined in claim 12 wherein the processing circuitry is further configured to:
receive, with the media guidance application, when a recording operation based on the updated recording instruction is completed by the media guidance application, a last information update associated with the media asset, the last information update associated with the media asset including at least the actual end time of the media asset; and
determine, using processing circuitry, whether the actual end time of the media asset is different than an estimated end time included in the updated recording instruction.

22. The system defined in claim 21 wherein the processing circuitry is further configured to:
if the actual end time is earlier than the estimated end time, send an instruction to the storage device to delete an excess recording; or
if the actual end time is later than the estimated end time, obtain missing recording content from a media source.

23-33. (canceled)
